(19) United States
(12) Patent Application Publication
(10) Pub. No.: US 2004/0261566 A1
(43) Pub. Date: Dec. 30, 2004

(54) Bicycle transmission control device

(76) Inventor: Bing-He Feng, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/823,747

(22) Filed: Apr. 14, 2004

(30) Foreign Application Priority Data
Jun. 27, 2003 (TW) 092211745

(51) Int. Cl. F16C 1/12

(52) U.S. Cl. 74/501.6

(57) ABSTRACT

A bicycle transmission control device includes a fixed housing fitted on a handlebar of the bicycle, one side of the housing being recessed to form an annular cavity in which a first locating section is disposed. A locking member having a first linking section and pivotably and slidably mounted in the annular cavity, one end of the locking member being formed with a second locating section, any end of the locking member being hooked with one end of the steel cord of the bicycle transmission system, the steel cord always resiliently pulling the locking member, whereby the second locating section is biased toward the first locating section to engage therewith. A rotary member fitted on the handlebar and pivotally mounted on outer side of the housing, a second linking section protruding from inner side of the rotary member for drivingly connecting with the first linking section of the locking member.

### BACKGROUND OF THE INVENTION

1. Field of the Invention

The present invention is related to a bicycle transmission control device in which a rotary member is drivingly connected with a locking member. A second locating section of the locking member can sequentially engage with a first locating section disposed on a sidewall of an annular cavity of a fixed housing.

2. Description of the Prior Arts

U.S. Pat. No. 5,476,019 discloses a bicycle transmission control device including a housing 16, a rotary member 18 and a resilient locking member 48. The resilient locking member 48 is disposed in a first linking section 42 of the housing 16 for snugly engaging with the locating teeth 52 of the rotary member 18. In addition, the rotary member 18 is tightly fixed with one end of the steel cord 66. When turning the rotary member 18, the steel cord 66 is wound by the rotary member 18 to shift the gear of the transmission mechanism of the bicycle.

In the above device, the rotary member 18 can be directly rotated to resiliently compress the resilient locking member 48 for winding the steel cord 66. However, in order to keep the rotary member 18 in a stable state at normal time, the resilient locking member 48 must have a considerably great resilient force for resisting against the resilient force of the spring of the transmission mechanism and stably locating the rotary member 18. As a result, it is laborious for a user to turn the rotary member.

In addition, the resilient locking member 48 always resiliently abuts against the locating teeth 52 and inner wall 56′ of the rotary member 18. When turning the rotary member 18, the rotary member 18 and the locking member 48 will abrade each other. After a period of use, the two members will be worn out. This will make the resilient locking member 48 no more able to tightly abut against the rotary member 18. Therefore, the using life is shortened.

Furthermore, the resilient locking member 18 is integrally made of a bent board body. After a long period of use, the resilient locking member 18 is apt to deform or elastically fail or break.

U.S. Pat. No. 6,021,688 discloses a bicycle transmission control device including a spring plate 43. An L-shaped end of the spring plate 43 is mounted in a split 424 of a tension ring 42. The L-shaped spring plate 43 and the tangent line of the tension ring 42 contain an angle (−θ). The inclined arched end 431 of the spring plate 43 is selectively latched with the positioning slots 411 of the arched plate 41 so as to locate the chain. Such structure is designed for overcoming the resilient force of the spring of the transmission so that the spring plate is inevitable.

U.S. Pat. No. 6,389,920 discloses a bicycle transmission control device including an elastomer 30 similar to the spring plate 43 of U.S. Pat. No. 6,021,688. The elastomer 30 must have a very high elasticity so as to keep the locating section 31 of the elastomer 30 resiliently abutting against the locating section 126 of the main body. When an operator winds the cord, the operator not only needs to overcome the resilient pulling force of the transmission cord, but also needs to apply a force for one by one retreating the elastomer 30, making the locating section 31 sequentially slidably latched in the locating section 126. This is the same in unwinding operation. Therefore, it is relatively strength-consuming to operate the device of U.S. Pat. No. 6,389,920. This problem also exists in the spring plate 43 of U.S. Pat. No. 6,021,688.

U.S. Pat. No. 6,484,604 of this applicant discloses a bicycle transmission control device including a cord-guiding link 23. One end of the cord-guiding link 23 is pivotally connected with the pivot section 37 of the rotary member 22. Only by means of the cam 38, the hook section 32 of the cord-guiding link 23 can be disengaged from the locating tooth 30.

### SUMMARY OF THE INVENTION

It is therefore a primary object of the present invention to provide a bicycle transmission control device including: a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system; a locating member having a first locating section disposed on one of the outer and inner circumferential walls of the annular cavity; a rotary member having a central through hole for fitting the rotary member on the handlebar; a turning member having a central through hole for fitting the turning member on the handlebar, the turning member being mounted on the rotary member, a linking section protruding from inner side of the turning member and extending into the annular cavity; and a locking member having a length larger than a width of the annular cavity, the locking member being pivotally drivable by the linking section of the turning member and slidable within the annular cavity of the fixed housing, one end of the locking member being formed with a second locating section, the other end of the steel cord being hooked with the other end of the locking member to, always resiliently pull the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

In the above bicycle transmission control device, one of the first locating section of the locating member and the second locating section of the locking member has multiple ratchets, while the other has at least one ratchet.

In the above bicycle transmission control device, the locking member includes a main body. A first end of the main body is formed with a second locating section. A dent is formed on a sideboard of the main body. The dent has a profile intersecting a moving path of the linking section, whereby the linking section of the turning member can press the profile of dent to forcedly make the second locating section of the locking member disengage from the first locating section of the fixed housing.

In the above bicycle transmission control device, the locating member is integrally formed on one of the inner and outer circumferential walls of the annular cavity.

In the above bicycle transmission control device, the locating member is integrally detachably mounted on one of the inner and outer circumferential walls of the annular cavity.

The above bicycle transmission control device further includes a leaf spring and a torque adjustment pad. The torque adjustment pad is fixed on a sidewall of the annular cavity. The torque adjustment pad is tapered in a winding direction of the steel cord. A first end of the leaf spring is fixed on the locking member. A second end of the leaf spring resiliently abuts against the torque adjustment pad.

In the above bicycle transmission control device, the torque adjustment pad is locked on the outer circumferential wall of the annular cavity by an adjustment screw. The adjustment screw is slidable and adjusted within a slide slot of the outer circumference of the annular cavity, whereby the position where torque adjustment pad is mounted on the sidewall of the annular cavity can be adjusted and a user can adjust the resistance against the rotary member according to a using state.

In the above bicycle transmission control device, one end of the torque adjustment pad is pivotally connected on the outer circumferential wall of the annular cavity. An adjustment screw is screwed through the outer circumference of the annular cavity into the other end of the torque adjustment pad, whereby by means of rotating the adjustment screw, the gradient of the torque adjustment pad relative to the annular cavity can be adjusted and a user can adjust the resistance against the rotary member according to a using state.

In the above bicycle transmission control device, the turning member is integrally formed on the rotary member.

In the above bicycle transmission control device, the turning member is detachably mounted on the rotary member.

It is a further object of the present invention to provide a bicycle transmission control device including: a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system; a locating member having a first locating section, the locating member being obliquely disposed in and across the annular cavity; a rotary member having a central through hole for fitting the rotary member on the handlebar; a turning member having a central through hole for fitting the turning member on the handlebar, the turning member being mounted on the rotary member, a linking section protruding from inner side of the turning member and extending into the annular cavity; and a locking member having a length larger than a width of the annular cavity, the locking member being pivotally drivable by the linking section of the turning member and slidable within the annular cavity of the fixed housing, one end of the locking member being formed with a second locating section, the other end of the steel cord being hooked with the end of the locking member where the second locating section is formed, the steel cord always resiliently pulling the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

In the above bicycle transmission control device, one of the first locating section of the locating member and the second locating section of the locking member has multiple ratchets, while the other has at least one ratchet.

In the above bicycle transmission control device, the locking member includes a main body. A first end of the main body is formed with a second locating section. A dent is formed on a sideboard of the main body. The dent has a profile intersecting a moving path of the linking section, whereby the linking section of the turning member can press the profile of dent to forcedly make the second locating section of the locking member disengage from the first locating section of the fixed housing.

In the above bicycle transmission control device, the locating member is integrally formed on one of the inner and outer circumferential walls of the annular cavity.

In the above bicycle transmission control device, the locating member is integrally detachably mounted on one of the inner and outer circumferential walls of the annular cavity.

In the above bicycle transmission control device, the turning member is integrally formed on the rotary member.

In the above bicycle transmission control device, the turning member is detachably mounted on the rotary member.

The above bicycle transmission control device further includes a leaf spring. Two ends of the leaf spring abut against the outer circumferential wall of the annular cavity. A section of the leaf spring abuts against the locking member, whereby the second locating section of the locking member abuts against the first locating section.

It is still a further object of the present invention to provide a bicycle transmission control device including: a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system; a locating member having a first locating section disposed on the outer circumferential walls of the annular cavity; a rotary member having a central through hole for fitting the rotary member on the handlebar; a turning member having a central through hole for fitting the turning member on the handlebar, the turning member being mounted on the rotary member, a linking section protruding from inner side of the turning member and extending into the annular cavity, the turning member further having a first unlatching section; and a locking member having a length larger than a width of the annular cavity, the locking member being pivotally drivable by the linking section of the turning member and slidable within the annular cavity of the fixed housing, one end of the locking member being formed with a second locating section and a second unlatching section, the second unlatching section being pushed by the first unlatching section to make the second locating section disengage from the first locating section, the other end of the steel cord being hooked with the other end of the locking member to always resiliently pull the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

In the above bicycle transmission control device, one of the first locating section of the locating member and the second locating section of the locking member has multiple ratchets, while the other has at least one ratchet.

In the above bicycle transmission control device, the locking member includes a main body. A first end of the main body is formed with a second locating section. A dent is formed on a sideboard of the main body. The dent has a profile intersecting a moving path of the linking section, whereby the linking section of the turning member can press the profile of dent to forcedly make the second locating section of the locking member disengage from the first locating section of the fixed housing.

In the above bicycle transmission control device, the locating member is integrally formed on one of the inner and outer circumferential walls of the annular cavity.

In the above bicycle transmission control device, the locating member is integrally detachably mounted on one of the inner and outer circumferential walls of the annular cavity.

The above bicycle transmission control device further includes a leaf spring and a torque adjustment pad. The torque adjustment pad is fixed on a sidewall of the annular cavity. The torque adjustment pad is tapered in a winding direction of the steel cord. A first end of the leaf spring is fixed on the locking member. A second end of the leaf spring resiliently abuts against the torque adjustment pad.

In the above bicycle transmission control device, the torque adjustment pad is locked on the outer circumferential wall of the annular cavity by an adjustment screw. The adjustment screw is slidable and adjusted within a slide slot of the outer circumference of the annular cavity, whereby the position where torque adjustment pad is mounted on the sidewall of the annular cavity can be adjusted and a user can adjust the resistance against the rotary member according to a using state.

In the above bicycle transmission control device, one end of the torque adjustment pad is pivotally connected on the outer circumferential wall of the annular cavity. An adjustment screw is screwed through the outer circumference of the annular cavity into the other end of the torque adjustment pad, whereby by means of rotating the adjustment screw, the gradient of the torque adjustment pad relative to the annular cavity can be adjusted and a user can adjust the resistance against the rotary member according to a using state.

In the above bicycle transmission control device, the turning member is integrally formed on the rotary member.

In the above bicycle transmission control device, the turning member is detachably mounted on the rotary member.

It is still a further object of the present invention to provide a bicycle transmission control device including: a fixed housing having a fixed through hole in which a handlebar of a bicycle is fitted, an inner circumferential wall and an outer circumferential wall being formed on one side of the fixed housing to define an annular cavity, the fixed housing further having an extension cavity having a slide passage, one end of the slide passage communicating with the annular cavity, the other end of the slide passage being formed with a cord hole, one end of a steel cord being conducted through the cord hole out of the fixed housing to connect with the transmission system of the bicycle; a locating member having a first locating section, the locating member being mounted on one sidewall of the slide passage of the extension cavity; a rotary member formed with a central through hole in which the handlebar of the bicycle is fitted, the rotary member having a first linking section; a locking member having a length larger than the width of the extension cavity, the locking member being pivotally drivable by the first linking section of the rotary member and slidably mounted in the extension cavity of the fixed housing, one end of the locking member being formed with a second locating section, the other end of the steel cord being latched with any end of the locking member, the locking member being always resiliently pulled by the steel cord to bias the second locating section toward the first locating section of the fixed housing, whereby the second locating section of the locking member is firmly engaged with the first locating section; and a link, one end of the link being pivotally connected with the locking member, the other end of the link being pivotally connected with the rotary member, by means of turning the rotary member, via the link, the locking member being driven to move along the slide passage of the extension cavity, whereby the locking member can be selectively located on the first locating section of the slide passage.

The above bicycle transmission control device further includes a slide member slidably disposed in the slide passage of the extension cavity. The slide member has a slide way in which the locking member is slidably disposed. The slide member has a second linking section for controlling the second locating section of the locking member to engage with the first locating section or disengage therefrom.

The above bicycle transmission control device further includes a spring plate. One end of the spring plate is fixed on the locking member. The other end of the spring plate is pressed against inner wall of the slide passage of the extension cavity to always bias the second locating section of the locking member toward the first locating section.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a partially sectional view taken along line 3-3 of FIG. 2;

FIG. 4 is a sectional view according to FIG. 3, in which the locking member is counterclockwise rotated by a certain angle and is to be moved to a next location;

FIG. 5 is a sectional view according to FIG. 4, in which the locking member is engaged in another location;

FIG. 6 is a sectional view according to FIG. 5, in which the locking member is clockwise rotated;

FIG. 7 is a sectional view according to FIG. 6, in which the locking member is engaged in another location;

FIG. 8 shows a second embodiment of the present invention;

FIG. 9 shows a third embodiment of the present invention;

FIG. 10 is a sectional view according to FIG. 9, in which the locking member is counterclockwise rotated by a certain angle and is to be moved to a next location;

FIG. 11 is a sectional view according to FIG. 9, in which the locking member is clockwise rotated and is to be moved to a next location;

FIG. 12 shows a fourth embodiment of the present invention;

FIG. 13 shows a fifth embodiment of the present invention;

FIG. 14 is a sectional view of the fifth embodiment of the present invention according to FIG. 13;

FIG. 15 shows a sixth embodiment of the present invention;

FIG. 16 shows a seventh embodiment of the present invention;

FIG. 17 shows an eighth embodiment of the present invention;

FIG. 18 is a view according to FIG. 17, showing that the locating member has been moved;

FIG. 19 shows a ninth embodiment of the present invention;

FIG. 20 is a perspective exploded view of a tenth embodiment of the present invention;

FIG. 21 is a perspective assembled view of the tenth embodiment of the present invention;

FIG. 22 is a sectional view taken along line 22-22 of FIG. 21;

FIG. 23 is a perspective assembled view of an eleventh embodiment of the present invention;

FIG. 24 is a sectional view of the eleventh embodiment of the present invention;

FIG. 25 is a sectional view taken along line 25-25 of FIG. 24; and

FIG. 26 is a perspective assembled view of a part of the eleventh embodiment of the present invention.

### DETAILED DESCRIPTION OF THE PREFERRED EMBODIMENTS

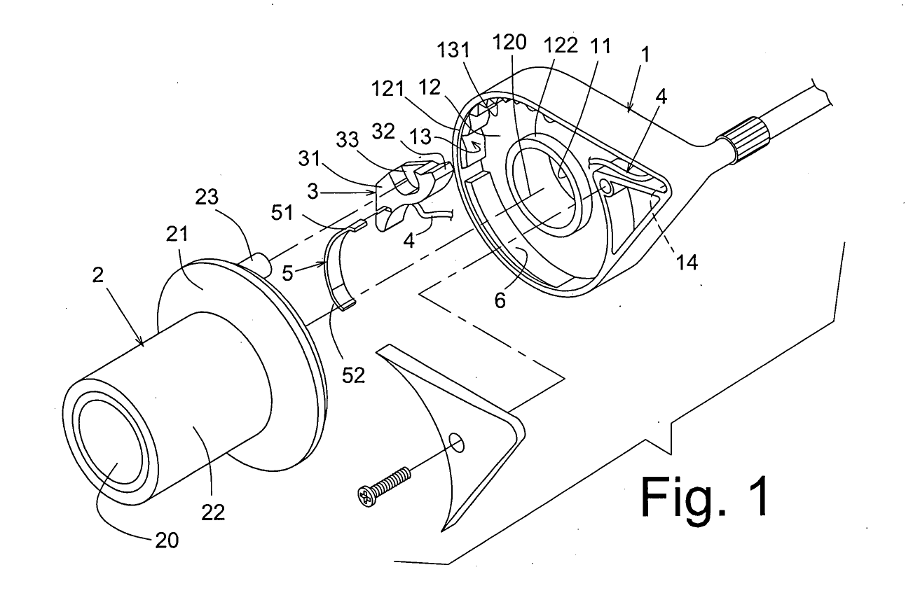

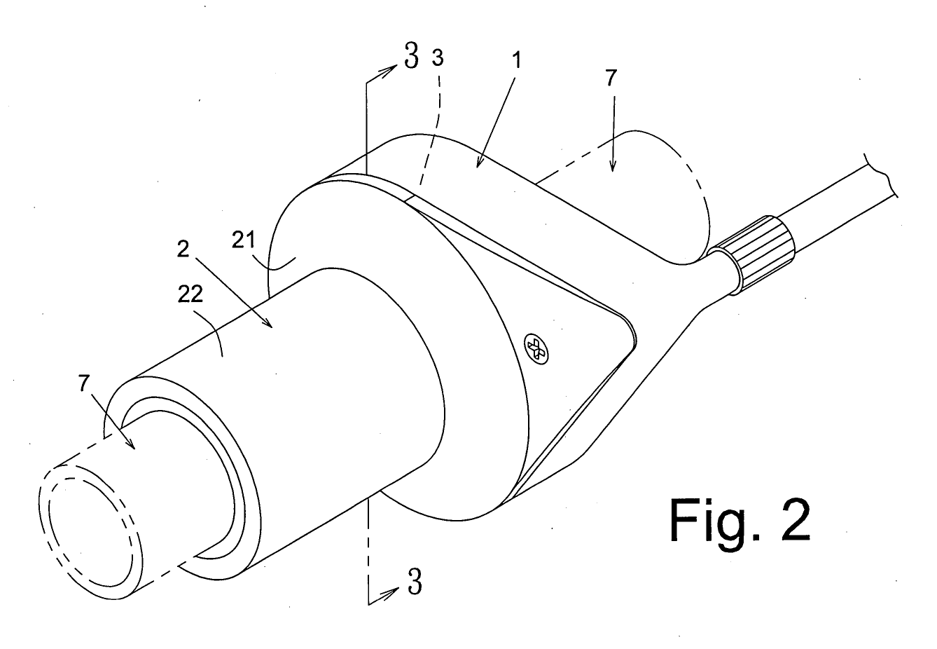

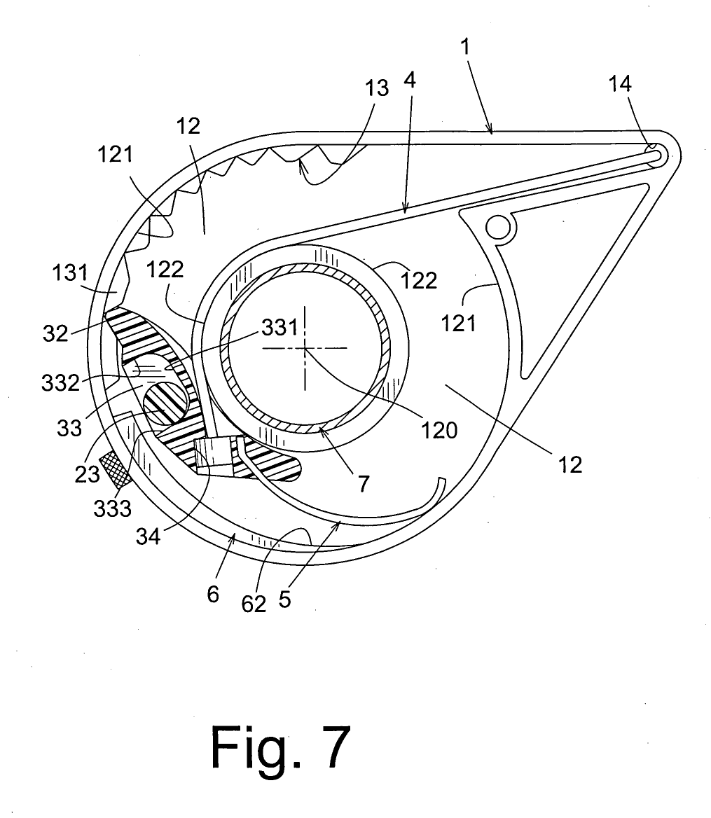

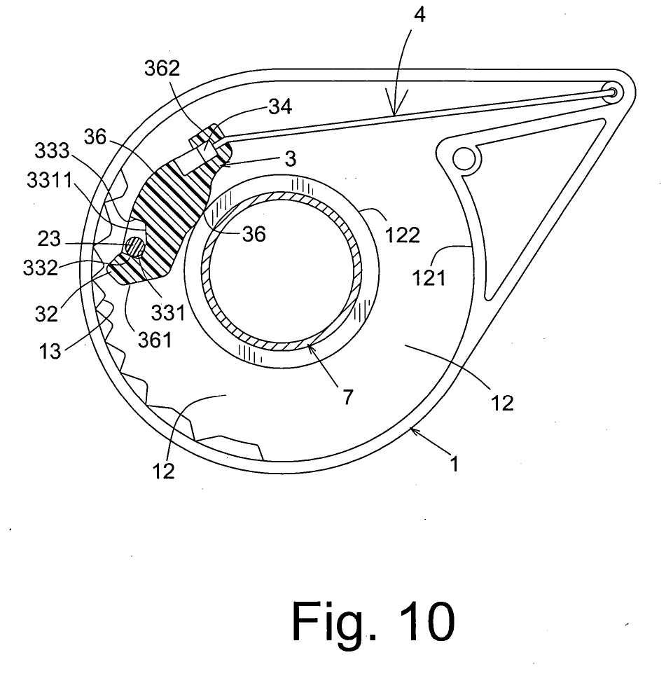

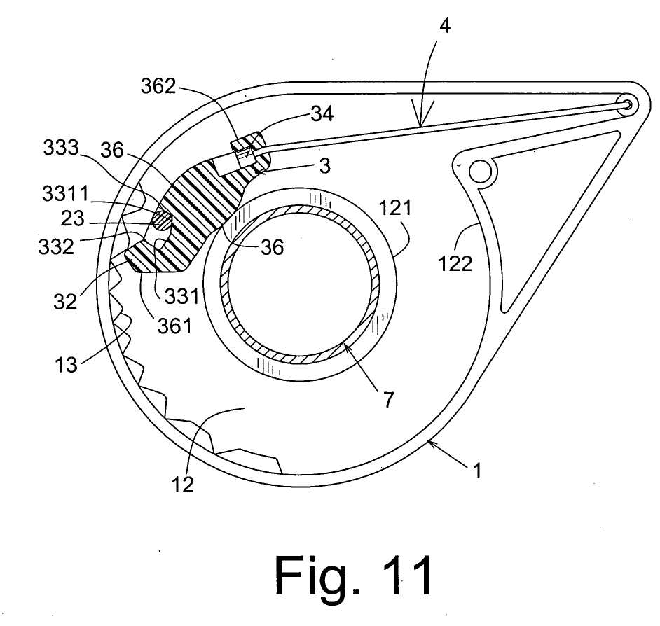

Please refer to FIGS. 1 to 11. The bicycle transmission control device of the present invention includes a fixed housing 1, a rotary member 2 and a locking member 3.

The fixed housing 1 is mounted on the handlebar 7 of the bicycle. One side of the housing 1 is recessed to form an annular cavity 12. A first locating section 13 is disposed on a sidewall of the annular cavity 12.

The locking member 3 has a first linking section 33. The length between two ends of the locking member 3 is larger than the width of the annular cavity 12. The locking member 3 is pivotally slidable within the annular cavity 12 of the fixed housing 1. One end of the locking member 3 is formed with a second locating section 32. The other end of the locking member 3 is hooked with any end of the steel cord 4 of the bicycle transmission system. The locking member 3 is always resiliently pulled by the steel cord 4, whereby the second locating section 32 is biased toward the first locating section 13 of the fixed housing 1 to engage therewith.

The rotary member 2 is pivotally mounted on one side of the fixed housing 1. A second linking section 23 protrudes from the rotary member 2 to drivingly connect with the first linking section 33. The second locating section 32 can engage with the first locating section 13 in different positions to wind or unwind the steel cord 4. The length of the locking member 3 is larger than the width of the annular cavity 12. In addition, the second locating section 32 and the steel cord 4 are respectively positioned at two different ends of the locking member 3. Therefore, when a spring at the other end of the steel cord 4 tensions the steel cord 4, the locking member 3 will rotate within the annular cavity 12. At this time, two ends of the locking member 3 will respectively contact with the outer circumferential wall 121 and inner circumferential wall 122 of the annular cavity 12 to prevent the locking member 3 from further rotating. Accordingly, the second locating section 32 of the locking member 3 will firmly engage with the first locating section 13. That is, the second locating section 32 of the locking member 3 will more tightly latch with the first locating section 13 of the fixed housing 1. Therefore, the resilient locking member 48 of the prior art can be omitted and the shortcoming existing in the prior art is eliminated.

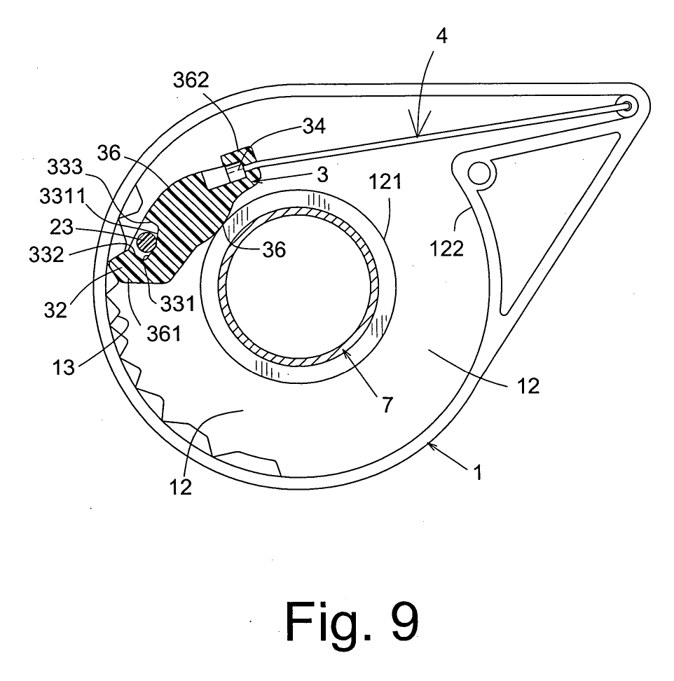

Referring to FIGS. 9, 10 and 11, the locking member 3 includes a pivoting section 36, a first section 361 and a second section 362. The first section 361 is positioned at one end of the pivoting section 36, while the second section 362 is positioned at the other end of the pivoting section 36. The pivoting section 36 is arch-shaped. The maximum width of the pivoting section 36 is slightly smaller than the width of the annular cavity 12, whereby the locking member 3 can slide within the annular cavity 12 and limitedly rotated within the annular cavity 12. The length of the locking member 3 is larger than the width of the annular cavity 12. In addition, the second locating section 32 and the steel cord 4 are respectively positioned at two different ends of the locking member 3. Therefore, when the spring at the other end of the steel cord 4 tensions the steel cord 4, the locking member 3 will rotate counterclockwise as shown in the figures. Under such circumstance, the second locating section 32 of the locking member 3 will more tightly latch with the first locating section 13 of the fixed housing 1.

Referring to FIGS. 1, 2 and 3, the fixed housing 1 has a fixing through hole 11 for fitting the housing 1 on the handlebar 7 of the bicycle. One end of the fixed housing 1 is formed with a cord hole 14. The steel cord 4 passes through the cord hole 14 out of the housing 1 to connect with the bicycle transmission system (not shown).

The first locating section 13 of the housing 1 has multiple ratchets 131. The ratchets 131 are arranged along the outer circumferential wall of the annular cavity 12 and centered at the circular center 120 of the annular cavity 12.

The rotary member 2 is formed with a central passage 20 for fitting the rotary member 2 on the handlebar 7 on outer side of the fixed housing 1. The rotary member 2 has a disc body 21 and a handle section 22 axially protruding from outer side of the disc body 21. A user can forcedly rotate the rotary member 2. The second linking section 23 is formed on inner side of the disc body 21. The second linking section 23 projects from the inner side of the disc body 21.

The locking member 3 includes a main body 31. A first end of the main body 31 is formed with a second locating section 32. The first linking section 33 is a dent formed on a sideboard of the main body 31 for accommodating the second linking section 23 of the rotary member 2. The first linking section 33 has a bottom section 331 and two dent walls 332, 333. The bottom section 331 has a slope section 3311. The bottom section 331, slope section 3311 and the two dent walls 332, 333 together form the profile of the dent. The bottom section 331 intersects the moving path of the second linking section 23. When the rotary member 2 is rotated in different directions, the second linking section 23 can press down the bottom section 331 of the first linking section 33 according to the rotational direction. Accordingly, the second locating section 32 of the locking member 3 will be temporarily biased from the first locating section 13 of the housing 1. The locking member 3 is formed with a cord hole 34 in which one end of the steel cord 4 is fitted. Alternatively, the second linking section 23 can be a dent, while the first linking section 33 can be a projection.

Referring to FIGS. 9 to 11, the slope section 3311 is formed on the bottom section 331 of the first linking section 33, whereby the closer to the dent wall 333 the first linking section 33 is, the shallower the first linking section 33 is. Accordingly, when the rotary member 2 is clockwise rotated, the second linking section 23 of the rotary member 2 will press the slope section 3311 of the bottom section 331 of the first linking section 33. At this time, the locking member 3 will be forcedly counterclockwise rotated about the pivoting section 36. Accordingly, the second locating section 32 of the locking member 3 will be temporarily biased from the first locating section 13 of the housing 1.

Referring to FIGS. 1, 2 and 3, the bicycle transmission control device of the present invention further includes a leaf spring 5 and a torque adjustment pad 6. The torque adjustment pad 6 is fixed on a sidewall of the annular cavity 12. The torque adjustment pad 6 is tapered in a winding direction of the steel cord 4. A first end 51 of the leaf spring 5 is inlaid in the locking member 3. A second end 52 of the leaf spring 5 resiliently abuts against the torque adjustment pad 6. When the rotary member 2 is rotated in an unwinding direction of the steel cord 4, that is, rotated clockwise, the leaf spring 5 is moved along with the locking member 3. At this time, the second end 52 of the leaf spring 5 is slid toward the thicker end 61 of the torque adjustment pad 6. Under such circumstance, the second end 52 more resiliently tightly abuts against the torque adjustment pad 6 to increase the frictional resistance. When a user releases the steel cord 4, the resilient pulling force applied to the steel cord 4 (by the spring of the transmission mechanism) is gradually reduced. However, the resistance between the leaf spring 5 and the torque adjustment pad 6 is increased so that when the user turns the rotary member 2 to release the steel cord 4, the rotary member 2 will not be easily abruptly turned due to the reduction of the pulling force exerted on the steel cord 4. Reversely, when the user turns the rotary member 2 to wind the steel cord 4, the second end 52 of the leaf spring 5 will move toward the thinner end 62 of the torque adjustment pad 6 to reduce the frictional resistance between the leaf spring 5 and the torque adjustment pad 6. The resilient pulling force applied to the steel cord 4 (by the spring of the transmission mechanism) is gradually increased. The increment of the frictional resistance and decrement of the pulling force result in that when rotating the rotary member 2 for winding or unwinding the steel cord 4, the user almost applies equal torque to the rotary member 2 for turning the same.

The torque adjustment pad 6 is locked on the outer circumferential wall 121 of the annular cavity 12 by an adjustment screw 63. The adjustment screw 63 can be slid and adjusted within a slide slot 15 of the outer circumference of the annular cavity 12, whereby the position where torque adjustment pad 6 is mounted on the outer circumferential wall 121 of the annular cavity 12 can be adjusted. Therefore, a user himself/herself can adjust the resistance against the rotary member 2 according to the using state.

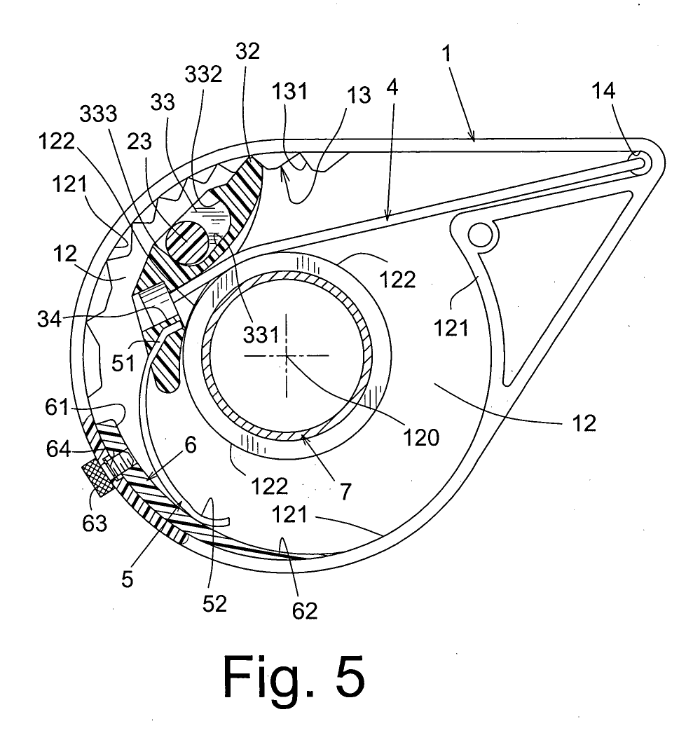

Besides, as shown in FIG. 5, the slide slot 15 can be omitted and the adjustment screw 63 is directly screwed through the outer circumference of the annular cavity 12 into the cavity 12. A C-shaped retainer ring 64 is inlaid in the outer circumferential wall 121 of the annular cavity 12 for retaining the adjustment screw 63, whereby the adjustment screw 63 can be freely rotated without dropping out from the outer circumference of the annular cavity 12. The adjustment screw 63 is further screwed into a thread hole of the torque adjustment pad 6. Simply by means of rotating the adjustment screw 63, the thicker end 61 of the torque adjustment pad 6 can be moved away from or close to the inner face of the outer circumferential wall of the annular cavity 12. That is, the gradient of the torque adjustment pad 6 can be adjusted. This can also achieve the object of adjustment of the resistance against the rotary member 2.

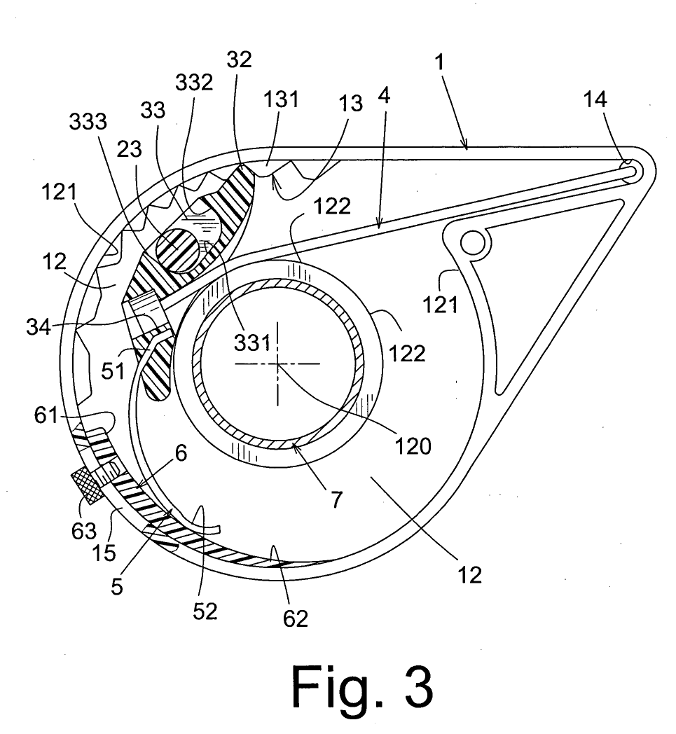

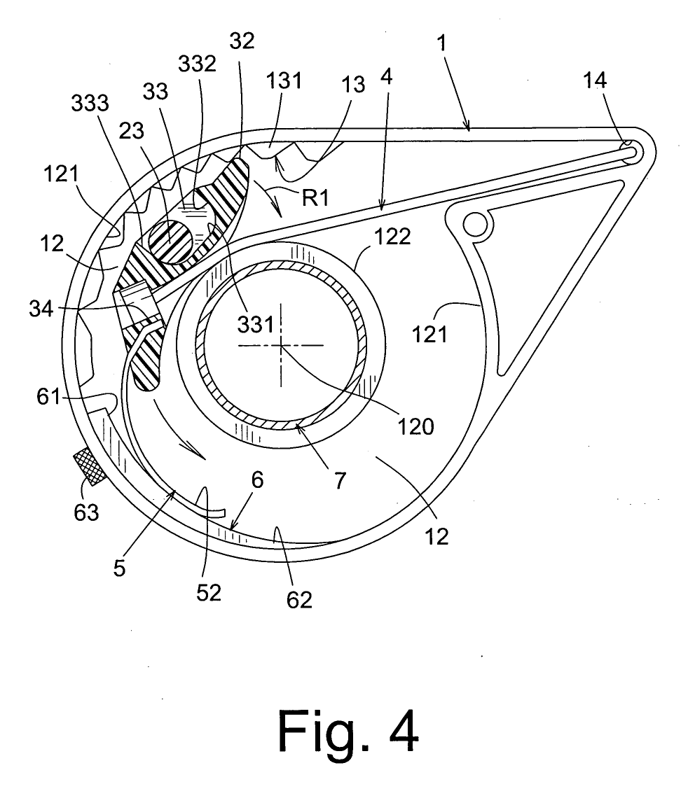

The second locating section 32 of the locking member 3 is a detent 32. When the rotary member 2 is rotated, the detent 32 can sequentially engage with the ratchets 131 of the first locating section 13 of the fixed housing 1. A user can counterclockwise turn the rotary member 2 from the engaged state of FIG. 3 to shift the gear of the bicycle. At this time, as shown in FIG. 4, the second linking section 23 presses down the bottom section 331 of the first linking section 33 of the locking member 3 and the dent wall 333 below the bottom section 331. Accordingly, the second locating section 32 of the locking member 3 is relatively pushed by the first locating section 13 of the fixed housing 1 and biased in a direction R1. At this time, the second locating section 32 is biased from the first locating section 13. The steel cord 4 always resiliently pulls the locking member 3, whereby the second locating section 32 of the locking member 3 tends to be biased to the first locating section 13. Therefore, when the rotary member is further counterclockwise rotated, the second locating section 32 will sequentially pass through the ratchets 131 of the first locating section 13 and snugly engage between two adjacent ratchets 131 of the first locating section 13. At this time, a click sound will be emitted as shown in FIG. 5. Accordingly, according to the using state, a user can turn the rotary member 2 by a certain angle to drive the locking member 3 for winding the steel cord 4.

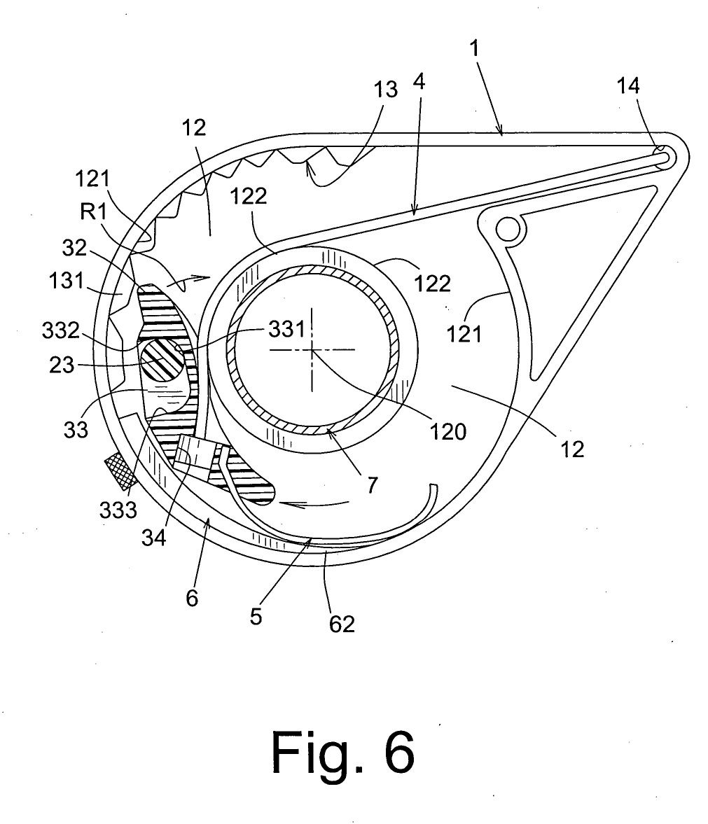

Referring to FIG. 6, when a user clockwise turns the rotary member 2, the second linking section 23 presses the bottom section 331 of the first linking section 33 of the locking member 3 and the dent wall 332 above the bottom section 331. At this time, the second locating section 32 of the locking member 3 is biased in a direction R1 and disengaged from the first locating section 13. After the rotary member 2 is turned to a desired position, the user stops turning the rotary member 2. The steel cord 4 always resiliently pulls the locking member 3, whereby the second locating section 32 of the locking member 3 is biased to the first locating section 13 with the second linking section 23 serving as a fulcrum. Therefore, the second locating section 32 can correspondingly engage between two adjacent ratchets 131 of the first locating section 13.

The locking member 3 is a block body free from the problems of deformation, elastic failure, etc. Furthermore, when shifting, the second linking section 23 can first bias the locking member 3 to make the second locating section 32 temporarily move away from the first locating section 13. Therefore, it is strength-saving and convenient to operate the present invention.

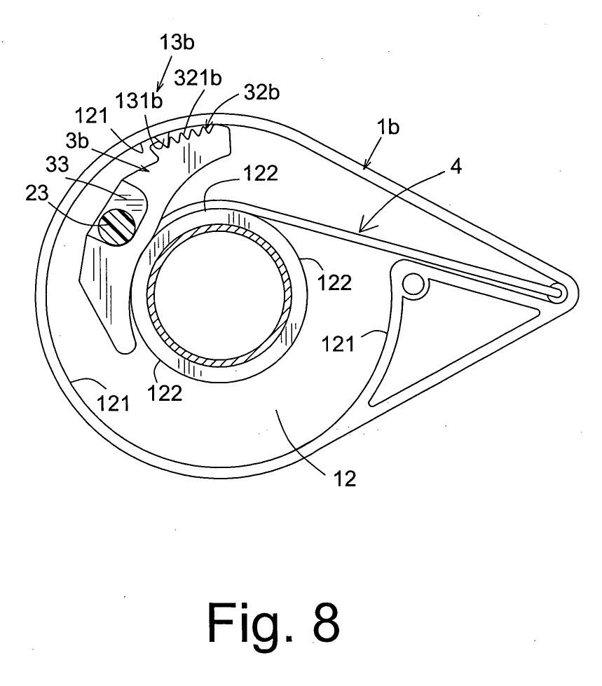

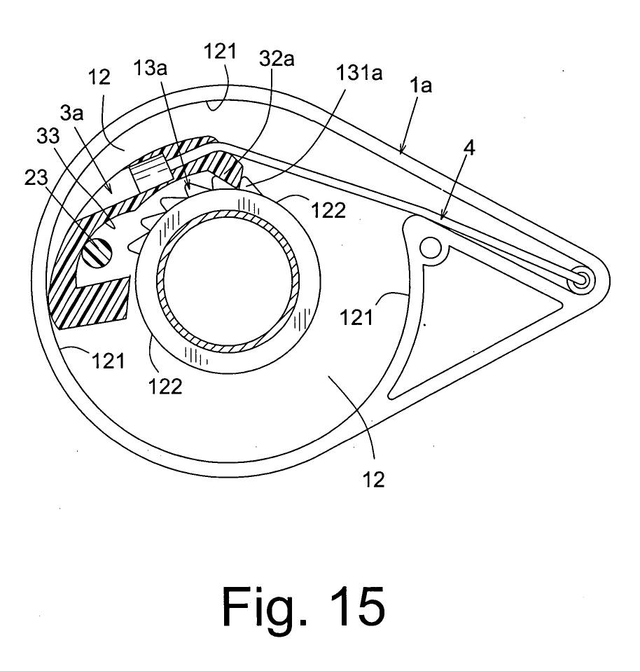

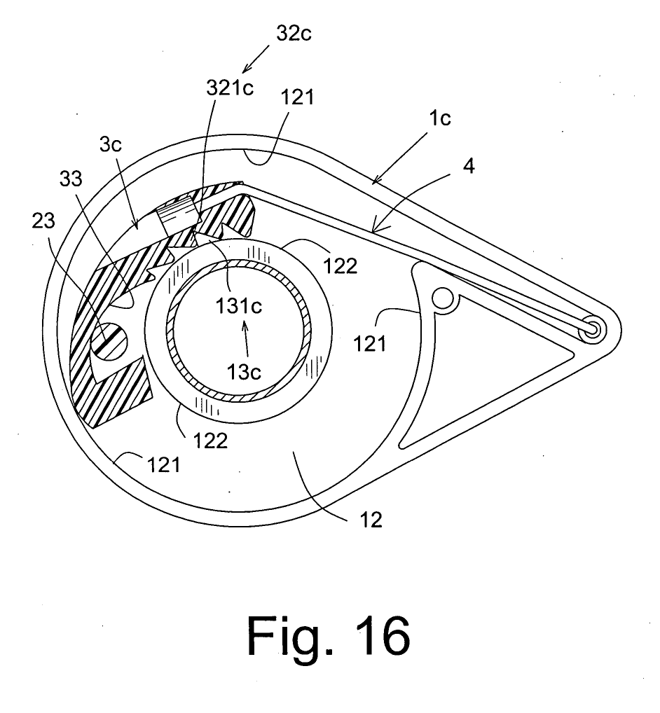

Referring to FIG. 3, the first locating section 13 of the housing 1 has multiple ratchets 131. The ratchets 131 are arranged along the outer circumferential wall 121 of the annular cavity 12 with equal radiuses. Alternatively, as shown in FIGS. 15 and 16, the first locating section 13a of the housing 1a has multiple ratchets 131a. The ratchets 131a are arranged along the inner circumferential wall 122 of the annular cavity 12 with equal radiuses. The second locating section 32a of the locking member 3a can be snugly engaged with the ratchets 131a. Alternatively, as shown in FIGS. 8 and 16, the first locating section 13b, 13c of the fixed housing 1b, 1c can have only one ratchet 131b, 131c, while the second locating section 32b, 32c of the locking member 3b, 3c can have multiple ratchets 321b, 321c arranged side by side. The arrangement of the ratchets of the present invention is not limited and can be modified. For example, the first locating section of the fixed housing can have one ratchet, while the second locating section of the locking member can have multiple ratchets. Alternatively, the first locating section of the fixed housing can have two ratchets, while the second locating section of the locking member can have multiple ratchets. Still alternatively, the first locating section of the fixed housing can have multiple ratchets and the second locating section of the locking member can also have multiple ratchets. Still alternatively, the first locating section of the fixed housing can have multiple ratchets, while the second locating section of the locking member can have only one ratchet. Still alternatively, the first locating section of the fixed housing can have multiple ratchets, while the second locating section of the locking member can have two ratchets.

FIGS. 9, 10, 11 show another embodiment of the present invention, which is different from the embodiment of FIGS. 1 to 7 in that the cord hole 34 and the second locating section 32 of the locking member 3 are respectively disposed at two ends thereof. Via the cord hole 34, the steel cord 4 applies a force to one end of the locking member 3. Accordingly, the locking member 3 is teetered to move the second locating section 32 at the other end of the locking member 3. The greater the force applied to one end of the locking member 3 by the steel cord 4 is, the greater engaging force applied to the first locating section 13 by the second locating section 32 of the other end of the locking member 3 is.

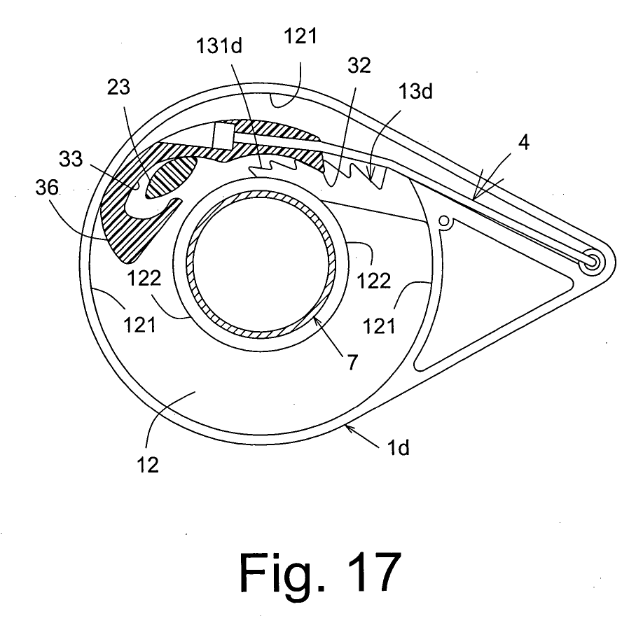

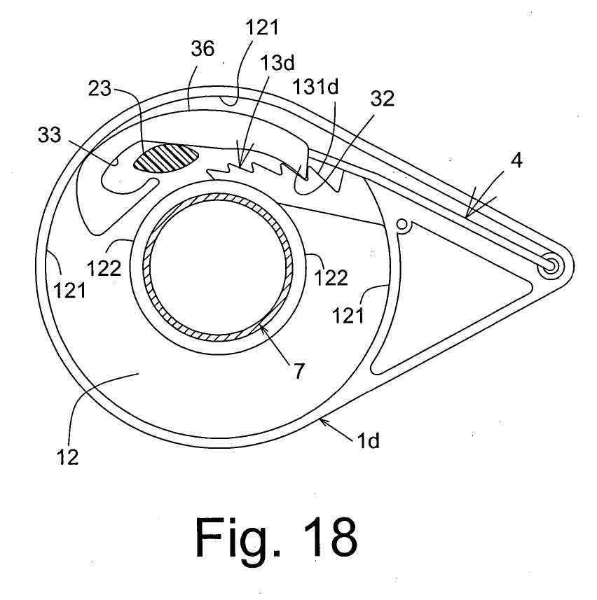

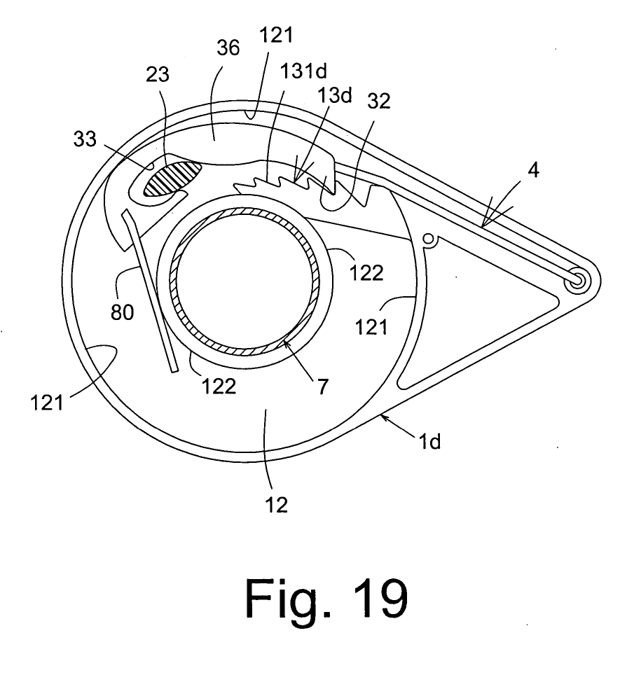

Referring to FIGS. 17, 18 and 19, the first locating section 13 obliquely crosses the annular cavity 12. As shown in FIG. 19, the bicycle transmission control device of the present invention further includes a leaf spring 80. Two ends of the leaf spring 80 abut against the outer circumferential wall 121 of the annular cavity 12. In addition, a section of the leaf spring 80 abuts against a lateral projecting section 38 of the locking member 3, whereby the second locating section 32 of the locking member 3 abuts against the first locating section 13d. When rotating the rotary member 2, the resilient force applied to the rotary member 2 by the spring of the transmission mechanism is varied. This will lead to the problem of uneven applied force. To solve this problem, the leaf spring 80 is used to bias the rotary member 2, whereby during the entire rotation procedure, the force is more evenly applied to the rotary member 2. In other words, when a user turns the rotary member 2 to shift, the user can more evenly exert a turning force onto the rotary member 2 without feeling that the turning force is gradually increased or decreased.

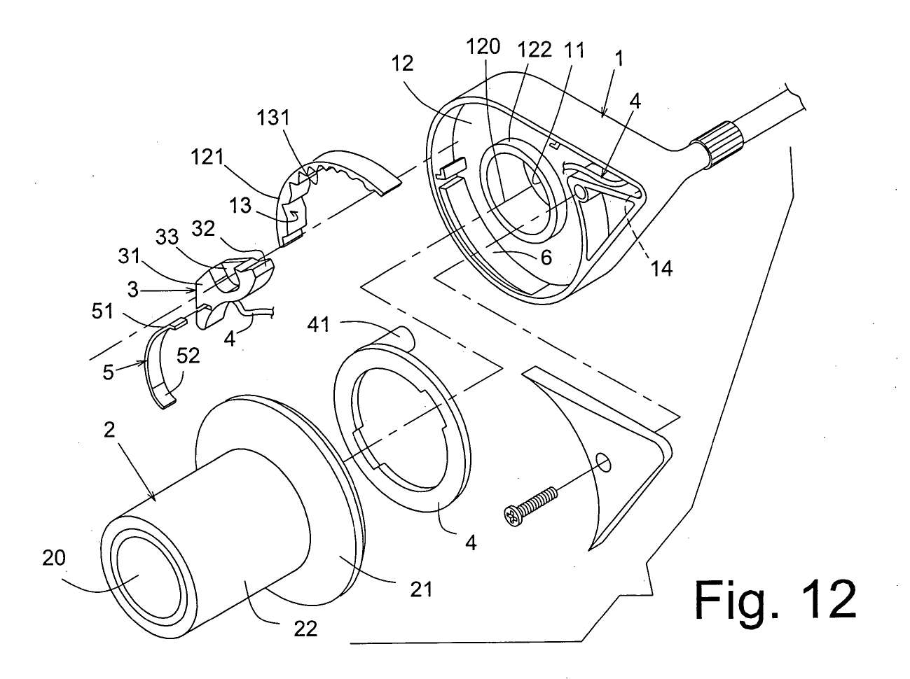

Referring to FIG. 12, the present invention further includes a turning member 9 having a central through hole 92 for fitting the turning member 9 on the handlebar. The turning member 9 is pivotally mounted on outer side of the rotary member 2. A linking section 91 protrudes from inner side of the turning member 9 and extends into the annular cavity 12. The turning member 9 can be integrated with the rotary member 2 to form one single member as shown in FIG. 1.

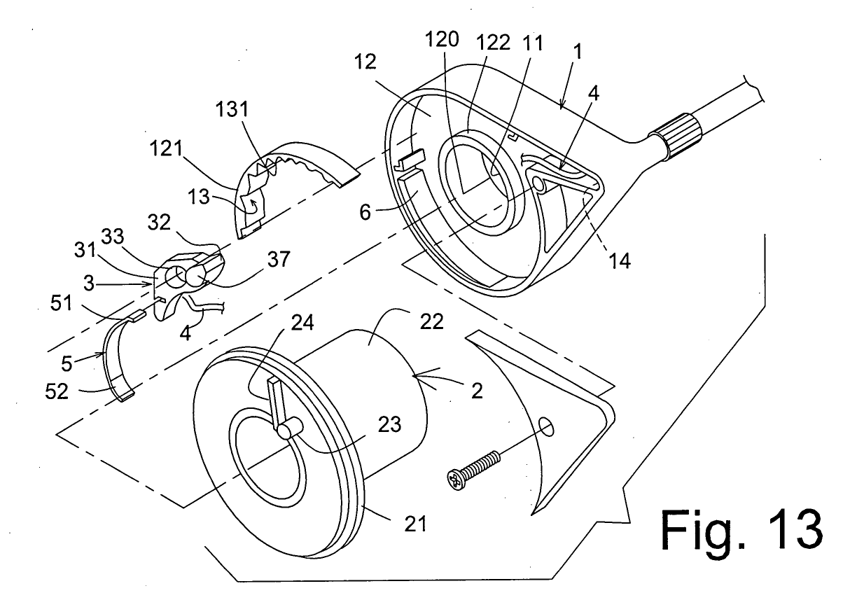

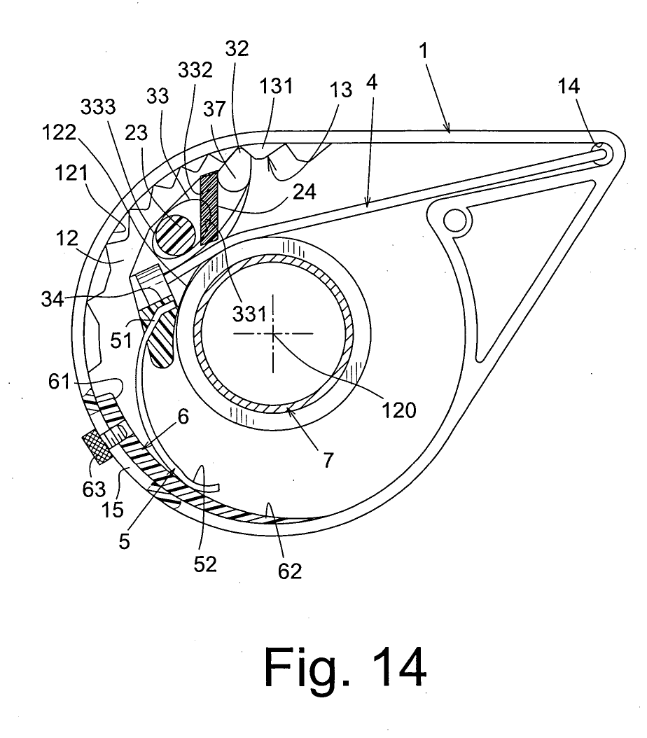

Referring to FIGS. 13 and 14, the rotary member 2 further has a first unlatching section 24 and the locking member 3 has a second unlatching section 37. The second unlatching section 37 is pushed by the first unlatching section 24 to disengage the second locating section 32 from the first locating section 13.

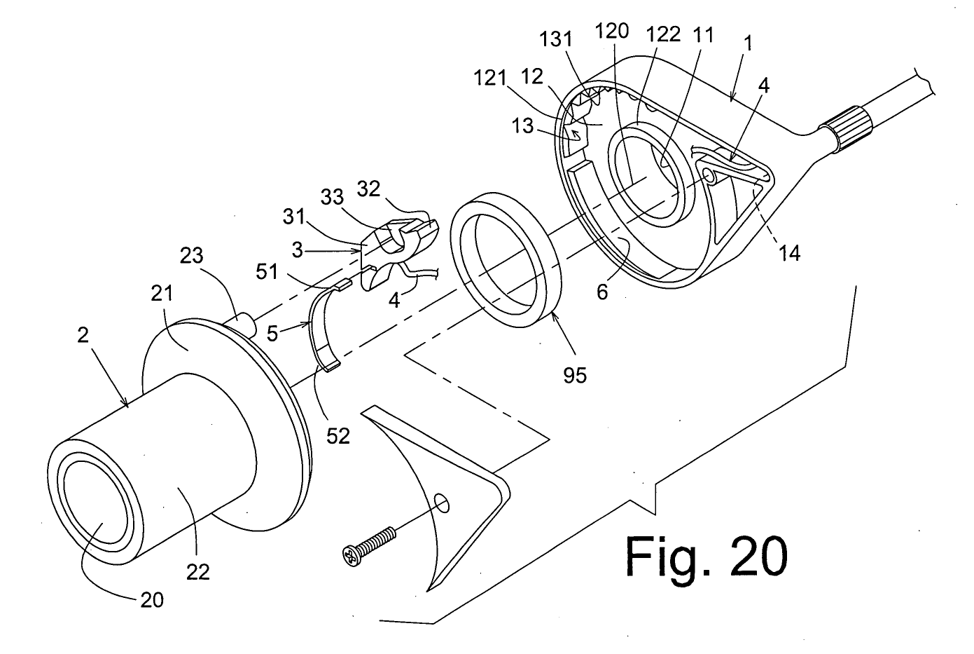

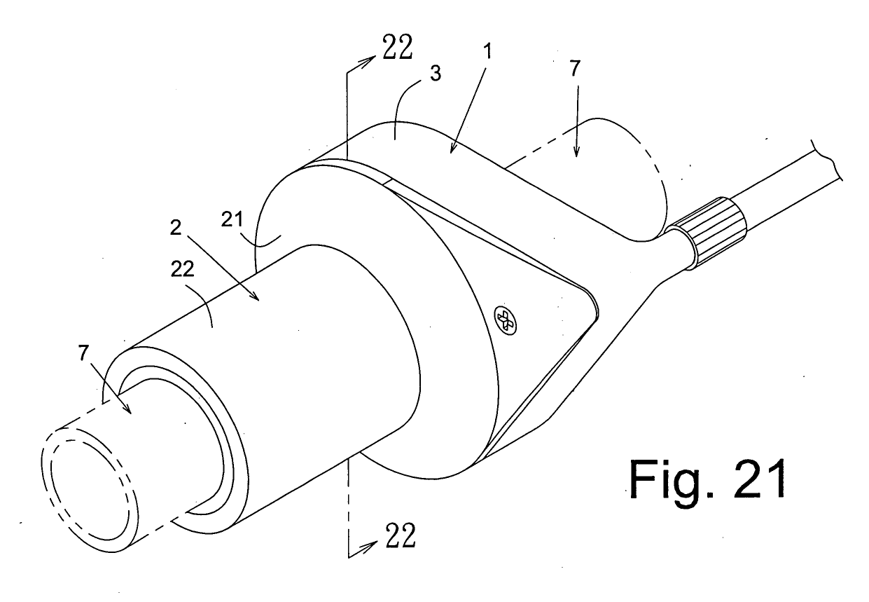

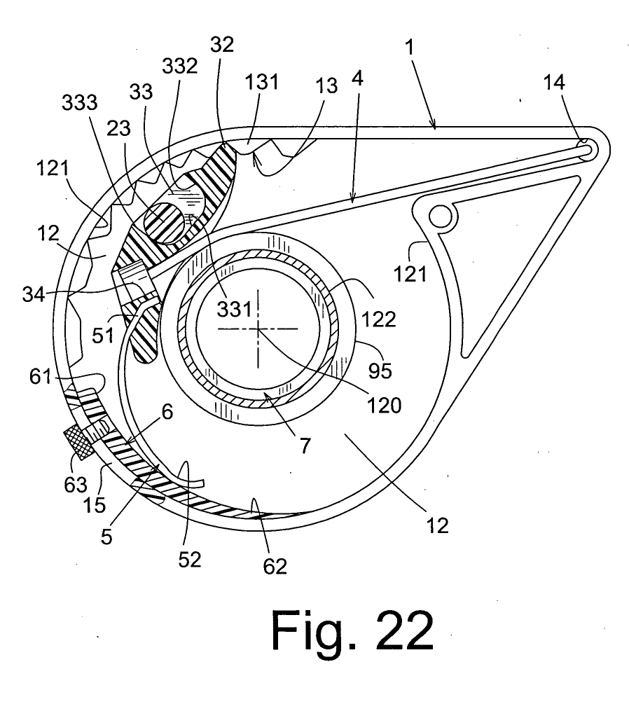

Referring to FIGS. 20, 21 and 22, a free ring 95 can be additionally fitted around the inner circumferential wall 122. The steel cord 4 can be directly pressed against outer circumference of the free ring 95. The free ring 95 can be freely rotated relative to the inner circumferential wall 122. Therefore, the steel cord 4 is prevented from directly abrading the inner circumferential wall 122 so as to reduce the resistance against the steel cord 4 when extensibly sliding.

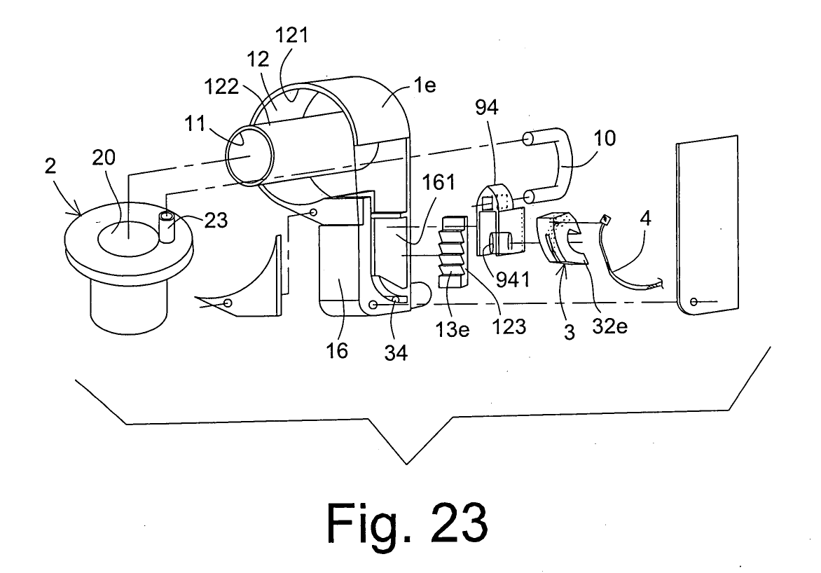

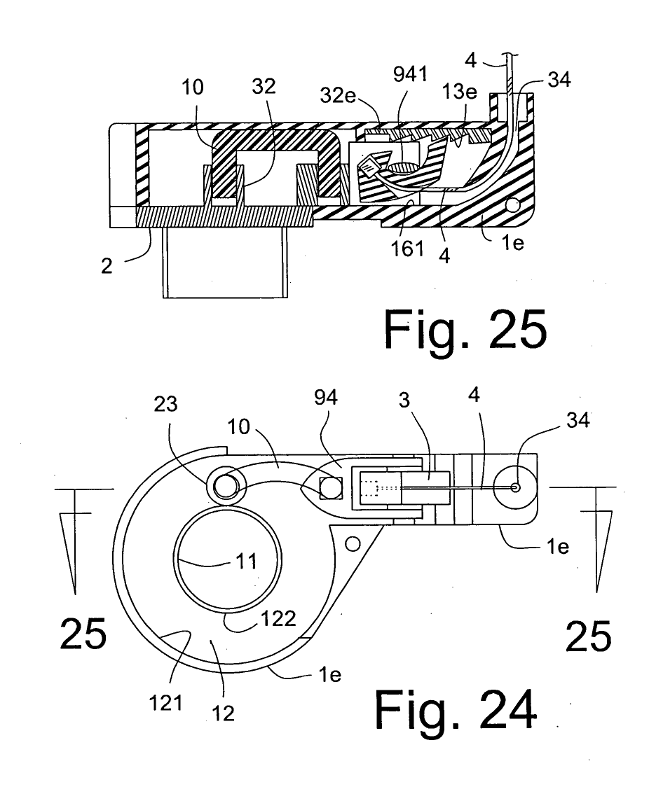

FIGS. 23, 24, 25 and 26 show still another embodiment of the bicycle transmission control device of the present invention, which includes a fixed housing 1e having a fixed through hole 11 in which the handlebar of the bicycle is fitted. An inner circumferential wall 122 and an outer circumferential wall 121 are formed on one side of the fixed housing 1e to define an annular cavity 12. The fixed housing 1e further has an extension cavity 16 having a slide passage 161. One end of the slide passage 161 communicates with the annular cavity 122. The other end of the slide passage 161 is formed with a cord hole 34. One end of the steel cord 4 is conducted through the cord hole 34 out of the fixed housing 1e to connect with the transmission system of the bicycle. The bicycle transmission control device further includes a locating member 123 having a first locating section 13e. The locating member 123 is mounted on one sidewall of the slide passage 161 of the extension cavity 16. The bicycle transmission control device further includes a rotary member 2 formed with a central through hole 20 in which the handlebar is fitted. The bicycle transmission control device further includes a locking member 3 having a length larger than the width of the extension cavity 16. The locking member 3 is pivotally drivable by the first linking section 23 of the rotary member 2 and slidably mounted in the extension cavity 16 of the fixed housing 1e. One end of the locking member 3 is formed with a second locating section 32e. The other end of the steel cord 4 is latched with the other end of the locking member 3. The locking member 3 is always resiliently pulled by the steel cord 4 to bias the second locating section 32e toward the first locating section 13e of the fixed housing 1e. Accordingly, the second locating section 32e of the locking member 3 is firmly engaged with the first locating section 13e. The bicycle transmission control device further includes a link 10. One end of the link 10 is pivotally connected with the locking member 3. The other end of the link 10 is pivotally connected with the rotary member 2. An operator can turn the rotary member 2 to via the link 10 drive the locking member 3 to move along the slide passage 161 of the extension cavity 16. Therefore, the locking member 3 can be selectively located on the first locating section 13e of the slide passage 161.

Referring to FIG. 23, the present invention further includes a slide member 94 slidably disposed in the slide passage 161 of the extension cavity 16. The slide member 94 has a slide way 940 in which the locking member 3 is slidably disposed. The slide member 94 has a second linking section 941 for controlling the second locating section 32e of the locking member 3 to engage with the first locating section 13e or disengage therefrom.

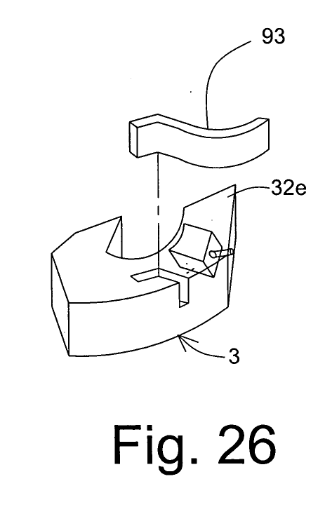

Referring to FIG. 26, a spring plate 93 is disposed on the locking member 3. The steel cord 4 is mounted at the same end of the locking member 3 as the second locating section 32e.

The present invention has the following advantages:

1. The conventional locking member 3 must overcome the resilient force of the spring of the transmission mechanism for engagement. Therefore, the stronger the resilient force of the spring is, the harder the locking member 3 is to fix. In contrast, in the present invention, the resilient force of the spring of the transmission mechanism is utilized for engagement. The stronger the resilient force of the spring is, the more firmly the locking member 3 is fixed.

2. The second locating section 32 of the locking member 3 can be biased by the second linking section 23 to temporarily unlatch from the fixed housing 1. Therefore, in operation, a user can save his/her strength relative to the conventional device. (In the conventional device, the resilient member always abuts against the fixed housing. Therefore, when turned, it is necessary to overcome the pulling force of the steel cord as well as the frictional resistance between the resilient member and the fixed housing.)

3. The locking member 3 of the present invention is a block body free from the problems of deformation, elastic failure, etc. Therefore, the using life is prolonged.

4. The locking member 3 of the present invention is drivingly connected with the second linking section 23 and slidable within the annular cavity 12 of the fixed housing 1 in a circular path. Therefore, the locking member 3 can be more smoothly engaged with the fixed housing 1.

The above embodiments are only used to illustrate the present invention, not intended to limit the scope thereof. Many modifications of the above embodiments can be made without departing from the spirit of the present invention.

What is claimed is:

1. A bicycle transmission control device comprising:
(a) a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system;
(b) a locating member having a first locating section disposed on one of the outer and inner circumferential walls of the annular cavity;
(c) a rotary member having a central through hole for fitting the rotary member on the handlebar;
(d) a turning member having a central through hole for fitting the turning member on the handlebar, the turning member being mounted on the rotary member, a linking section protruding from inner side of the turning member and extending into the annular cavity; and
(e) a locking member having a length larger than a width of the annular cavity, the locking member being pivotally drivable by the linking section of the turning member and slidable within the annular cavity of the fixed housing, one end of the locking member being formed with a second locating section, the other end of the steel cord being hooked with the other end of the locking member to always resiliently pull the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

2. The bicycle transmission control device as claimed in claim 1, wherein one of the first locating section of the locating member and the second locating section of the locking member has multiple ratchets, while the other has at least one ratchet.

3. The bicycle transmission control device as claimed in claim 1, wherein the locking member includes a main body, a first end of the main body being formed with a second locating section, a dent being formed on a sideboard of the main body, the dent having a profile intersecting a moving path of the linking section, whereby the linking section of the turning member can press the profile of dent to forcedly make the second locating section of the locking member disengage from the first locating section of the fixed housing.

4. The bicycle transmission control device as claimed in claim 1, wherein the locating member is integrally formed on one of the inner and outer circumferential walls of the annular cavity.

5. The bicycle transmission control device as claimed in claim 1, wherein the locating member is integrally detachably mounted on one of the inner and outer circumferential walls of the annular cavity.

6. The bicycle transmission control device as claimed in claim 1, further comprising a leaf spring and a torque adjustment pad, the torque adjustment pad being fixed on a sidewall of the annular cavity, the torque adjustment pad being tapered in a winding direction of the steel cord, a first end of the leaf spring being fixed on the locking member, a second end of the leaf spring resiliently abutting against the torque adjustment pad.

7. The bicycle transmission control device as claimed in claim 6, wherein the torque adjustment pad is locked on the outer circumferential wall of the annular cavity by an adjustment screw, the adjustment screw being slidable and adjusted within a slide slot of the outer circumference of the annular cavity, whereby the position where torque adjustment pad is mounted on the sidewall of the annular cavity can be adjusted and a user can adjust the resistance against the rotary member according to a using state.

8. The bicycle transmission control device as claimed in claim 6, wherein one end of the torque adjustment pad is pivotally connected on the outer circumferential wall of the annular cavity, an adjustment screw being screwed through the outer circumference of the annular cavity into the other end of the torque adjustment pad, whereby by means of rotating the adjustment screw, the gradient of the torque adjustment pad relative to the annular cavity can be adjusted and a user can adjust the resistance against the rotary member according to a using state.

9. The bicycle transmission control device as claimed in claim 1, wherein the turning member is integrally formed on the rotary member.

10. The bicycle transmission control device as claimed in claim 1, wherein the turning member is detachably mounted on the rotary member.

11. A bicycle transmission control device comprising:
(a) a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system;
(b) a locating member having a first locating section, the locating member being obliquely disposed in and across the annular cavity;
(c) a rotary member having a central through hole for fitting the rotary member on the handlebar;
(d) a turning member having a central through hole for fitting the turning member on the handlebar, the turning member being mounted on the rotary member, a linking section protruding from inner side of the turning member and extending into the annular cavity; and
(e) a locking member having a length larger than a width of the annular cavity, the locking member being pivotally drivable by the linking section of the turning member and slidable within the annular cavity of the fixed housing, one end of the locking member being formed with a second locating section, the other end of the steel cord being hooked with the end of the locking member where the second locating section is formed, the steel cord always resiliently pulling the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

12. The bicycle transmission control device as claimed in claim 11, wherein one of the first locating section of the locating member and the second locating section of the locking member has multiple ratchets, while the other has at least one ratchet.

13. The bicycle transmission control device as claimed in claim 11, wherein the locking member includes a main body, a first end of the main body being formed with a second locating section, a dent being formed on a sideboard of the main body, the dent having a profile intersecting a moving path of the linking section, whereby the linking section of the turning member can press the profile of dent to forcedly make the second locating section of the locking member disengage from the first locating section of the fixed housing.

14. The bicycle transmission control device as claimed in claim 11, wherein the locating member is integrally formed on one of the inner and outer circumferential walls of the annular cavity.

15. The bicycle transmission control device as claimed in claim 11, wherein the locating member is integrally detachably mounted on one of the inner and outer circumferential walls of the annular cavity.

16. The bicycle transmission control device as claimed in claim 11, wherein the turning member is integrally formed on the rotary member.

17. The bicycle transmission control device as claimed in claim 16, wherein the turning member is detachably mounted on the rotary member.

18. The bicycle transmission control device as claimed in claim 11, further comprising a leaf spring, two ends of the leaf spring abutting against the outer circumferential wall of the annular cavity, a section of the leaf spring abutting against the locking member, whereby the second locating section of the locking member abuts against the first locating section.

19. A bicycle transmission control device comprising:
(a) a fixed housing having a fixing through hole for fitting the housing on a handlebar of the bicycle, one side of the housing being recessed to form an annular cavity having an inner and an outer circumferential walls, one end of the fixed housing being formed with a cord hole, one end of a steel cord passing through the cord hole out of the housing to connect with the bicycle transmission system;
(b) a locating member having a first locating section disposed on the outer circumferential walls of the annular cavity;
(c) a rotary member having a central through hole for fitting the rotary member on the handlebar;
(d) a turning member having a central through hole for fitting the turning member on the handlebar, the turning member being mounted on the rotary member, a linking section protruding from inner side of the turning member and extending into the annular cavity, the turning member further having a first unlatching section; and
(e) a locking member having a length larger than a width of the annular cavity, the locking member being pivotally drivable by the linking section of the turning member and slidable within the annular cavity of the fixed housing, one end of the locking member being formed with a second locating section and a second unlatching section, the second unlatching section being pushed by the first unlatching section to make the second locating section disengage from the first locating section, the other end of the steel cord being hooked with the other end of the locking member to always resiliently pull the locking member, whereby the second locating section is biased toward the first locating section of the fixed housing, the length of the locking member being larger than the width of the annular cavity so that when the locking member is pivotally rotated within the annular cavity, two ends of the locking member will respectively abut against the outer and inner circumferential walls of the annular cavity to prevent the locking member from further rotating, whereby the second locating section of the locking member will firmly engage with the first locating section.

20. The bicycle transmission control device as claimed in claim 19, wherein one of the first locating section of the locating member and the second locating section of the locking member has multiple ratchets, while the other has at least one ratchet.

21. The bicycle transmission control device as claimed in claim 19, wherein the locking member includes a main body, a first end of the main body being formed with a second locating section, a dent being formed on a sideboard of the main body, the dent having a profile intersecting a moving path of the linking section, whereby the linking section of the turning member can press the profile of dent to forcedly make the second locating section of the locking member disengage from the first locating section of the fixed housing.

22. The bicycle transmission control device as claimed in claim 19, wherein the locating member is integrally formed on one of the inner and outer circumferential walls of the annular cavity.

23. The bicycle transmission control device as claimed in claim 19, wherein the locating member is integrally detachably mounted on one of the inner and outer circumferential walls of the annular cavity.

24. The bicycle transmission control device as claimed in claim 19, further comprising a leaf spring and a torque adjustment pad, the torque adjustment pad being fixed on a sidewall of the annular cavity, the torque adjustment pad being tapered in a winding direction of the steel cord, a first end of the leaf spring being fixed on the locking member, a second end of the leaf spring resiliently abutting against the torque adjustment pad.

25. The bicycle transmission control device as claimed in claim 24, wherein the torque adjustment pad is locked on the outer circumferential wall of the annular cavity by an adjustment screw, the adjustment screw being slidable and adjusted within a slide slot of the outer circumference of the annular cavity, whereby the position where torque adjustment pad is mounted on the sidewall of the annular cavity can be adjusted and a user can adjust the resistance against the rotary member according to a using state.

26. The bicycle transmission control device as claimed in claim 24, wherein one end of the torque adjustment pad is pivotally connected on the outer circumferential wall of the annular cavity, an adjustment screw being screwed through the outer circumference of the annular cavity into the other end of the torque adjustment pad, whereby by means of rotating the adjustment screw, the gradient of the torque adjustment pad relative to the annular cavity can be adjusted and a user can adjust the resistance against the rotary member according to a using state.

27. The bicycle transmission control device as claimed in claim 19, wherein the turning member is integrally formed on the rotary member.

28. The bicycle transmission control device as claimed in claim 27, wherein the turning member is detachably mounted on the rotary member.

29. The bicycle transmission control device as claimed in claim 27, further comprising a free ring which is rotatably fitted around the inner circumferential wall, the steel cord being directly pressed against outer circumference of the free ring, whereby the free ring can be freely rotated relative to the inner circumferential wall to prevent the steel cord from directly abrading the inner circumferential wall so as to reduce the resistance against the steel cord when extensibly sliding.

30. A bicycle transmission control device comprising:
(a) a fixed housing having a fixed through hole in which a handlebar of a bicycle is fitted, an inner circumferential wall and an outer circumferential wall being formed on one side of the fixed housing to define an annular cavity, the fixed housing further having an extension cavity having a slide passage, one end of the slide passage communicating with the annular cavity, the other end of the slide passage being formed with a cord hole, one end of a steel cord being conducted through the cord hole out of the fixed housing to connect with the transmission system of the bicycle;
(b) a locating member having a first locating section, the locating member being mounted on one sidewall of the slide passage of the extension cavity;
(c) a rotary member formed with a central through hole in which the handlebar of the bicycle is fitted, the rotary member having a first linking section;
(d) a locking member having a length larger than the width of the extension cavity, the locking member being pivotally drivable by the first linking section of the rotary member and slidably mounted in the extension cavity of the fixed housing, one end of the locking member being formed with a second locating section, the other end of the steel cord being latched with any end of the locking member, the locking member being always resiliently pulled by the steel cord to bias the second locating section toward the first locating section of the fixed housing, whereby the second locating section of the locking member is firmly engaged with the first locating section; and
(e) a link, one end of the link being pivotally connected with the locking member, the other end of the link being pivotally connected with the rotary member, by means of turning the rotary member, via the link, the locking member being driven to move along the slide passage of the extension cavity, whereby the locking member can be selectively located on the first locating section of the slide passage.

31. The bicycle transmission control device as claimed in claim 30, further comprising a slide member slidably disposed in the slide passage of the extension cavity, the slide member having a slide way in which the locking member is slidably disposed, the slide member having a second linking section for controlling the second locating section of the locking member to engage with the first locating section or disengage therefrom.

32. The bicycle transmission control device as claimed in claim 30, further comprising a spring plate, one end of the spring plate being fixed on the locking member, the other end of the spring plate being pressed against inner wall of the slide passage of the extension cavity to always bias the second locating section of the locking member toward the first locating section.
